(19) United States
(12) Patent Application Publication
(10) Pub. No.: US 2026/0058827 A1
(43) Pub. Date: Feb. 26, 2026

(54) TRUST VERIFICATION FOR CONSENT-FREE OUT-OF-BAND MANAGEMENT OF ENDPOINT DEVICES

(71) Applicant: Intel Corporation, Santa Clara, CA (US)

(72) Inventors: Garritt Christian Binder, Leola, SD (US); Novin Kaihani, Tualatin, OR (US); James Jonathan Medell, Beaverton, OR (US); Tsippy Mendelson, Modiin (IL); Junhai Qiu, Portland, OR (US)

(73) Assignee: Intel Corporation, Santa Clara, CA (US)

(21) Appl. No.: 19/371,755

(22) Filed: Oct. 28, 2025

(51) Int. Cl. H04L 9/32

(52) U.S. Cl. CPC H04L 9/3247; H04L 9/3213; H04L 9/3263; H04L 9/3271

(57) ABSTRACT

A user may register with a fleet system responsible for remote management of a fleet of endpoint devices. The fleet system can determine a level of trust for the user based on information associated with an email address of the user and other information and register the user if the determined level of trust is sufficient. The registered user can request an activation token to be used for provisioning an endpoint device for consent-free out-of-band management. An endpoint device can be provisioned by the user submitting the activation token to the fleet service, the fleet service sending the activation token to the endpoint device, the endpoint device generating an ownership voucher request that includes the activation token, the fleet service verifying and validating the ownership voucher request, the fleet service returning a signed ownership voucher to the endpoint device, and the endpoint device verifying the signed ownership voucher.

### BACKGROUND

Consent-free out-of-band management refers to the ability of a remote administrator to perform management functions on a computing device (an endpoint device) without requiring interaction or approval from a local user of the computing device. In GOB management, management commands may be executed through a dedicated management subsystem of the endpoint device regardless of the state of the host operating system. This allows operations such as remote power control, boot configuration, and keyboard-video-mouse (KVM) access to be carried out transparently, enabling enterprise administrators to maintain, update, or remediate endpoint devices at scale.

### BRIEF DESCRIPTION OF THE DRAWINGS

FIG. 1 illustrates an example sequence diagram for registering a user with an out-of-band management service and provisioning an endpoint device for out-of-band management.

FIG. 2 is an example method performed by a fleet server as part of provisioning an endpoint device for consent-free out-of-band management.

FIG. 3 is an example method performed by an endpoint device as part of provisioning the endpoint device for consent-free out-of-band management.

FIG. 4 is a block diagram of an example computing system in which technologies described herein may be implemented.

FIG. 5 is a block diagram of an example processor unit to execute computer-executable instructions as part of implementing technologies described herein.

### DETAILED DESCRIPTION

In enterprise and other contexts in which a large fleet of computing devices (or endpoint devices) are under the management of a central or distributed team (e.g., an information technology (IT) department), remote management of the computing device fleet is desirable. It is convenient to be able to control endpoint devices remotely in an out-of-band management mode. Out-of-band (OOB) management is a remote management capability that operates independently of an endpoint device's main operating system, using a dedicated management subsystem or separate network channel. OOB management allows administrators to perform various device management tasks remotely, such as power on/off, BIOS (built-in operating system)/firmware updates, and keyboard-video-mouse (KVM) access even when the endpoint device operating system is down or unresponsive.

Intel® Active Management Technology (AMT) is one example of an out-of-band (OOB) management framework. Intel® AMT is a hardware-based OOB solution integrated into Intel computing device platforms as part of an Intel® Management Engine (ME)/Converged Security Management Engine (CSME)). Intel® Active Management Technology (AMT) may be operated in one of two control modes: client control mode and admin control mode. Client control mode is a lower-privilege mode in which some out-of-band operations (e.g., KVM redirection) are permitted only after explicit local user consent. Admin control mode is a higher-privilege mode in which administrative out-of-band operations may be executed without requiring local user consent.

OOB management is valuable for large-scale provisioning, troubleshooting, and recovery, but it requires careful security controls as it provides low-level access to endpoint devices. Consent-free OOB management presents heightened security concerns as it lacks the check of a local user granting OOB management privileges to a remote administrator. The security concerns associated with consent-free OOB management have led to existing OOB management implementations requiring, for example, that an IT administrator be in physical proximity of the endpoint device. The risk associated with not having a local user authorize remote endpoint device management and the inconveniences associated with existing consent-free OOB management has prevented consent-free OOB management from being adopted at scale.

Described herein are technologies that provide for automated trust verification for consent-free out-of-band management of endpoint devices. A trust level for a user (e.g., an information technology administrator) desiring to register with an OOB management service is established automatically based on internet registry and other information. If the trust level is sufficient, the user is registered with the service and granted an activation token that the user can submit to the service when they wish to provision an endpoint device for consent-free OOB management. Upon the user submitting the activation token, the service then executes a provisioning sequence that delivers or confirms a root of trust to the endpoint device, and the endpoint device is provisioned for consent-free OOB management. The technologies described herein have at least the advantages of enabling consent-free OOB management of endpoint devices securely and at scale.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

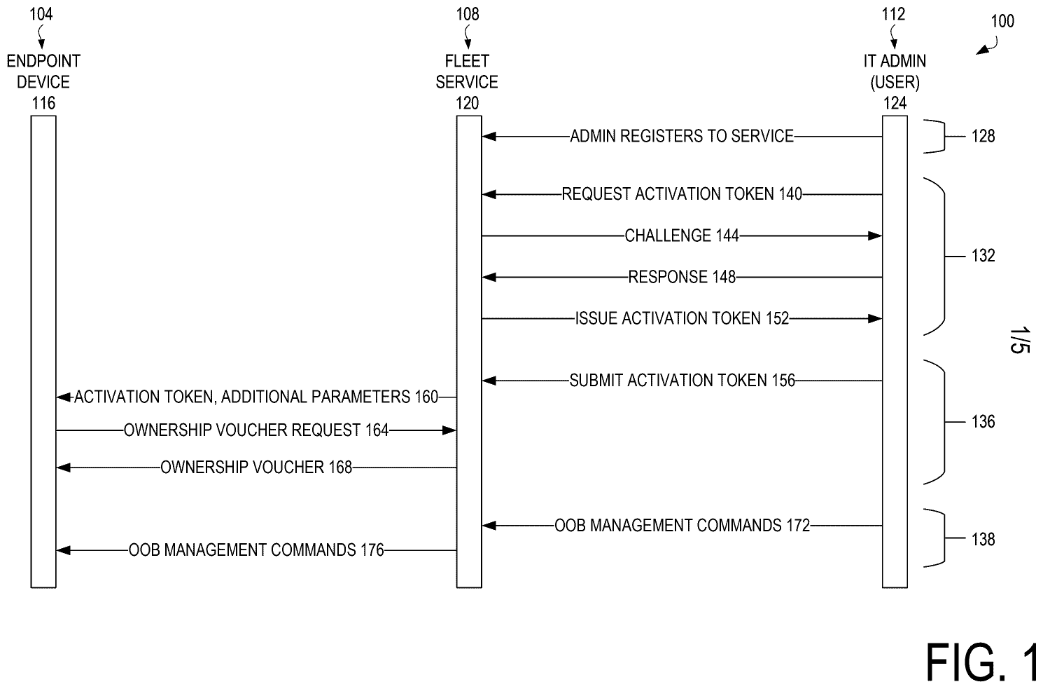

FIG. 1 illustrates an example sequence diagram for registering a user with an out-of-band management service and provisioning an endpoint device for out-of-band management. The sequence diagram 100 comprises lanes 104, 108, and 112 and illustrates interactions between an information technology (IT) administrator (user 124), a fleet service 120, and an endpoint device 116 to register the user 124 with the fleet service 120 and provision the endpoint device 116 for consent-free out-of-band management by the user 124. The user 124 can be any user responsible for the remote management of endpoint devices. The fleet service 120 provides a central platform for managing a fleet of endpoint devices. Instead of configuring or monitoring devices individually, IT administrators and other authorized users registered with the fleet service 120 can use the fleet service to provision, update, and control endpoint device at scale from a single, remote interface. The endpoint device 116 can be any computing device that connects to a network and is subject to centralized out-of-band management. The endpoint device 116 can be, for example, a server, workstation, desktop computer, laptop computer, tablet computer, smartphone, thin client (e.g., a computing device having limited local resources and relying on a remote computing device for execution of applications, data storage, and management), or another network-enabled device deployed to an end user. The endpoint device 116 can execute client-side software or agents configured to enable monitoring, updating, or control by the fleet service 120.

The sequence illustrated in FIG. 1 is broken down into four stages. In a first stage 128, the user 124 registers with the fleet service 120. In a second stage 132, the user 124 requests an activation token from the fleet service 120. In a third stage 136, the user 124 uses the activation token to provision an endpoint device 116 for remote out-of-band administration by the user 124 in a consent-free manner. In a fourth stage 138, the user 124 performs consent-free out-of-band management of the endpoint device 116.

In the first stage 128, the user 124 registers with the fleet service 120. The fleet service 120 determines a level of trust for the user 124 before registering the user 124 to utilize the fleet service's central management platform. For example, the fleet service 120 can evaluate one or more trust indicators to determine a level of trust for a user 124. In some embodiments, for each trust indicator, if the trust indicator indicates the user should be trusted, the fleet service 120 increases a trust score, and if the trust indicator indicates the user should not be trusted, the fleet service 120 decreases a trust score. In some embodiments, a user is deemed trustworthy and is registered with the fleet service 120 if the level of trust (such as a trust score) determined by the fleet service 120 meets or exceeds a trust threshold level and the user is not deemed trustworthy and is not registered with the fleet service 120 if the level of trust determined by the fleet service 120 falls below a second trust threshold level. In various embodiments, the first trust threshold level and the second trust threshold level can be the same or different. In the case where they are different, if a level of trust determined based on an initial set of trust indicators does not resolve whether a user can be trusted or not (for example, the level of trust does not meet or exceed a first trust threshold indicating that a user is to be trusted and the level of trust does not fall below a second trust threshold indicating that a user is not to be trusted), the fleet service can add one or more additional trust indicators to be included in the determination of the level of trust. Thus, in some embodiments, the fleet service applies an adaptive approach to determining the level of trust for a user.

In any of the embodiments disclosed herein, the fleet service 120 can determine a level of trust for the user based at least in part on one or more of the user's email address, the internet protocol (IP) address of the email server to which the user's email address maps to by a domain name server, and information that can obtained based on the user's email address or associated with the email server IP address.

In any of the embodiments disclosed herein, the fleet service 120 can determine a level of trust for a user 124 based at least in part on one or more of the following: domain registration information associated with a user's email address, name server information associated with a user's email address, verification of a user's email address, and verification of a domain associated with a user's email address. Domain registration information associated with a user's email address includes information provided to a domain name registrar (e.g., GoDaddy) as part of registering a domain name (e.g., “company.com”) and information maintained by a domain name registrar or a top-level domain (TLD) registry as part of maintaining a domain name registration. Domain registration information can be obtained from a TLD registry, a domain name registrar, or a domain name registration data query service, such as the ICAAN (Internet Corporation for Assigned Names and Numbers) WHOIS or RDAP (Registration Data Access Protocol) protocols.

Examples of domain registration information include domain activities dates, such as a registration date, an update date, or an expiration date. If any of these activity dates are recent, they can indicate that a domain associated with a user may not be trustworthy, due to, for example, the domain not being well established or well established but recently sold. Trust indicators related to domain activity dates can include, for example, a registration date, an update date, or an expiration date that is within a threshold period of time from a current time (e.g., within the last week).

Additional examples of domain registration information include domain codes (domain status codes). In some embodiments, domain codes can be in accordance with an Extensible Provisioning Protocol (EPP) domain management framework. A domain code specifies an operational, administrative, or security state of a domain name, and can be used to determine, for example, whether a domain is active, locked, or abandoned, or suggest that the domain may not be trustworthy.

Certain domain codes indicate that a domain is active or locked. For example, the code “ok” represents a default status indicating the domain is active, not subject to any pending operations, and permitted to resolve normally. Locking codes may be applied to a domain prevent unauthorized changes. For instance, the codes “clientTransferProhibited” and “serverTransferProhibited” indicate that a registrar or registry, respectively, has locked the domain against transfer. The codes “clientUpdateProhibited” and “serverUpdateProhibited” indicate that a registrar or registry, respectively, has prohibited modification of the domain information. Likewise, the codes “clientDeleteProhibited” and “serverDeleteProhibited” indicate that a registrar or registry, respectively, has prohibited deletion of the domain. Together, these codes represent states in which a domain is either operational or restricted to prevent unauthorized activity. Any domain code indicating that a domain associated with a user's email address is active or locked can be a trust indicator.

Other domain codes can indicate that a domain is abandoned or otherwise not trustworthy. For example, the code “pendingDelete” indicates that the domain has expired and is in a final state before deletion, after which the domain cannot be restored. The code “redemptionPeriod” indicates that the domain has expired and is in a grace period in which the registrant may restore the domain upon payment of associated fees, while the code “pendingRestore” indicates that a request to restore the domain has been submitted but has not yet been completed. Additional codes may suggest suspension or instability, such as “clientHold” and “serverHold”, which prevent the domain from resolving in DNS due to registrar or registry action, respectively. The code “inactive” indicates that the domain lacks valid name server records and is therefore non-functional despite being registered. The code “pendingTransfer” indicates that the domain is in the process of being transferred between registrars, a state that, while not always abandoned, may indicate instability or risk of unauthorized transfer. Any of these domain codes indicating that a domain associated with a user's email address is abandoned or otherwise not trustworthy can be a trust indicator.

Further examples of domain registration information include registrar information and registrant information. Domain name registrars are entities that provide domain registration services to end users. Information regarding the registrar's identity itself may be used as trust indicators for establishing user trustworthiness, as domains obtained through registrars known for rigorous verification and low abuse rates may be deemed more credible, while domains obtained through registrars with lax verification procedures or high incidence of abusive registrations may be deemed less credible. Thus, in some embodiments, a trust indicator can be the presence of a registrar on an allowlist of registrars deemed credible or on a denylist of registrars deemed not credible.

Registrant information refers to any data associated with a user, organization, or entity that has registered a domain name through a registrar. The registrant information can be maintained by a registrar or registry. Registrant information can include, for example, a user's or entity's name, address, and/or telephone number. A trust indicator can be whether any such registrant information is redacted from a domain record (although redaction could be due to compliance with privacy regulations or laws, such as the European Union's General Data Protection Regulations). Another trust indicator can be if all (or most) contact information fields for a registrant are populated or if all (or most) of these fields are empty.

Additional examples of domain registration information include domain name server information, such as the location of a domain name server or the name server domain associated with a user's email address. A “name server” refers to a computing system that resolves a domain name into an associated network address. In certain embodiments, a “name server domain” refers to the domain name under which a name server is registered, such as the domain component of a name server hostname (e.g., in the name server hostname “ns.example.com”, the name server domain is “example.com”). The location of a name server may be inferred by resolving the name server hostname to an Internet Protocol (IP) address using a domain name system (DNS) lookup, and then evaluating information associated with the IP address. For example, the IP address of a name server may be mapped to an autonomous system number (ASN) owned by an organization that operates in a specific geographic region, an internet service provider that serves a specific geographic region, or a geographic region using publicly available allocation databases, routing records, or geolocation services.

The inferred location of a name server and/or the name server domain may be used be used by a fleet service in determining a level of trust for a user. For example, domains whose name servers resolve to IP addresses associated with hosting providers or geographic regions associated with malicious activity may be deemed less trustworthy, while domains whose name servers resolve to IP addresses associated with well-established infrastructure providers or regions with low incidence of malicious activity may be deemed more credible. Likewise, domains that specify name servers under name server domains with a reputation for stability and low levels of malicious activity may be considered more trustworthy, whereas domains associated with high level of malicious activity may be considered less credible.

Thus, in some embodiments, a trust indicator for determining a level of trust for a user can be whether an inferred location of a name server is on an allowlist of geographic regions deemed trustworthy or on a denylist of geographic regions deemed not trustworthy. Similarly, a trust indicator for determining a level of trust for a user can be whether a domain name of a name server is on an allowlist of name server domains deemed trustworthy or on a denylist of name server domains deemed not trustworthy. In some embodiments, the fleet service can utilize a third-party site or service to determine whether a name server domain is on an allowlist or denylist.

Examples of name server information include various domain name system (DNS) records maintained by a name server that defines an operational parameter of a domain, such as the domain associated with a user's email address. Examples of DNS records include address (A or AAAA) records, name server (NS) records, mail exchange (MX) records, canonical name (CNAME) records, start of authority (SOA) records, and text (TXT) records. An address record (A or AAAA) associates a domain name with a network address, such as an internet protocol version 4 (IPv4) or internet protocol version 6 (IPv6) address, thereby enabling client devices to resolve the domain name into a routable address. In some embodiments, a trust indicator used by a fleet service to determine a level of trust for a user can be whether the network address associated with a DNS address record of a name server associated a user's email address is associated with a geographic location that is on a denylist or allowlist. A geographic location associated with a DNS address record can be inferred as described above in regard to determining a geographic location of a name server domain via a DNS lookup.

A name server (NS) record specifies the name servers responsible for a domain, thereby delegating resolution of the domain to designated name server domains. In some embodiments, a trust indicator used by a fleet service to determine a level of trust for a user can be whether the name server domains listed in an NS record matches those provided by a registration data query service (e.g., WHOIS, RDAP). In some embodiments, a trust indicator used by a fleet service to determine a trust level of a user can be whether one or more of the name server domains listed in an NS record are on a denylist or allowlist.

A mail exchange (MX) record designates the domain names of one or more servers responsible for handling electronic mail messages associated with the domain. In some embodiments, a trust indicator can be determining whether the highest priority email server or one or more other email servers indicated by the MX record provide a disposable or temporary email service. A temporary or disposable email service refers to a service that provides short-term, non-persistent email addresses, typically without identity verification, wherein the addresses are configured to automatically expire after a defined period of time. In some embodiments, a trust indicator used by a fleet service to determine a level of trust for a user can be whether the highest priority email server or one or more other email servers indicated by the MX record provides a common or shared email service. A common or shared email provider refers to an electronic mail service that issues accounts to the general public under widely used domains, such as gmail.com.

A canonical name (CNAME) record defines an alias relationship between a first domain name and a second canonical domain name, such that queries for the first domain resolve to the resources of the second domain. In some embodiments, a trust indicator used by a fleet service to determine a level of trust for a user can be performing any of the checks described above relating to a domain name, network address associated with a domain, or a geographic location of a domain name to determine the trustworthiness of the canonical domain name.

A start of authority (SOA) record specifies administrative metadata for a domain, including an authoritative name server, contact information, and timing parameters for zone transfers and cache updates. A text (TXT) record stores arbitrary textual information associated with a domain, which may be used to specify authentication data, security policies, or verification information. In some embodiments, a trust indicator used by a fleet service to determine a level of trust for a user can be determining whether one or more fields of an SOA record are properly populated or whether a TXT record is populated.

In some embodiments, a fleet service can utilize the domain information group (dig) command-line tool to query DNS servers and provides DNS record information for a given domain to obtain domain information and/or name server information.

In some embodiments, a trust indicator for determining a level of trust for a user can be performing email verification, such as by sending a test message to a provided email address and confirming that it is successfully delivered. A response from the recipient, such as clicking a verification link, provides confirmation that the email account is active and accessible by the user. In some embodiments, a trust indicator can be successful delivery of a test email message to an email address association with a user and/or successful receipt of a response to the test email message. In some embodiments, email verification can be performed after a cooling off period. Such a cooling period can be important because, for example, disposable email services can have a limited lifespan and to handle scenarios where an unauthorized user has temporary access to an email account (e.g., an IT admin walks away from their laptop for several minutes while in a public place) and it is unlikely the same unauthorized user will have access to that email account at a later time. In another email verification technique, a fleet system could instruct a user to expect an email at a certain date and time, and the user must send an appropriate response to that email within a short timespan (e.g., a few minutes). That is, email verification can be performed after a specified amount of time has passed since a user provided their email address to a fleet service as part of registering for the service. In some embodiments, as will be discussed further below, after an initial email verification is performed as part of a user registering for the fleet service, a subsequent email verification can be performed as part of a user requesting an activation token to provision an endpoint device for out-of-band management.

In some embodiments, a fleet service can perform verification of a domain associated with a user's email address as part of determining a level of trust for a user. In some embodiments, a fleet service can connect to the domain associated with a user's address to confirm the presence of the domain as a trust indicator.

In some embodiments, one or more trust indicators that a fleet service can utilize to determine a level of trust for a user can be determining that the domain associated with the user's email address has a transport layer security (TLS) certificate (an indication that the user can be trusted), the TLS certificate roots to a trusted certificate authority (the user can be trusted), the TLS certificate is currently valid (the user can be trusted), the TLS certificate has not recently expired or been revoked (an indication that the user cannot be trusted), the TLS certificate has been recently created (i.e., such as within a threshold period of time from a current time, an indication that the user cannot be trusted), the domain name matches a domain name in the TLS certificate indicating which domains the TLS certificate is valid for (i.e., the TLS certificate's common name (CN) or subject alternative names (SANs), an indication that the user can be trusted), and that wildcards are used in the domain names to extend the TLS certificate validity to multiple domains (the user cannot be trusted). A TLS certificate for a domain can be chained to a certificate authority (CA) through one or more intermediate certificates and rooted to a trusted CA included in a fleet service computing device's trust store, thereby establishing a verifiable chain of trust for the certificate.

Trust indicators that a user is trustworthy can further include evidence that a domain web site associated with the user's email is actively maintained to remain effective against techniques used to bypass website security. Such maintenance can encompass applying server and software patches, such as updating the operating system, web-server software (e.g., Apache, Nginx, IIS), and supporting libraries, frameworks, or cryptographic components (e.g., OpenSSL, PHP, Node.js), as well as updating content-management systems and associated plugins or modules (e.g., WordPress and third-party extensions). Trust indicators may further include revising web-application-firewall (WAF) rules and detection heuristics to block new injection vectors, cross-site-scripting (XSS) bypasses, and other web-based evasion methods, and hardening authentication and bot-detection mechanisms by enhancing CAPTCHA challenges, adjusting rate-limiting and device-fingerprinting policies, and enforcing multi-factor authentication.

Domain web site maintenance can also include managing Transport Layer Security (TLS) configurations, such as renewing domain TLS certificates, disabling deprecated protocols (e.g., SSLv3, TLS 1.0/1.1), and enforcing strong cipher suites-together with DNS and infrastructure-security changes such as deploying or renewing DNSSEC, adjusting name-server configurations, and mitigating hijacking or spoofing attempts. Additional measures include revising email-authentication records (SPF, DKIM, DMARC) to prevent spoofing or phishing; integrating threat intelligence by refreshing blocklists of malicious IP addresses, disposable email providers, proxy services, or botnets and ingesting updated feeds; and updating monitoring and anomaly-detection baselines by tuning logging rules, alert thresholds, and historical models to more effectively detect novel circumvention activity. In some embodiments, a time at which any of the above maintenance activities are taken (e.g., the date a software patch was applied or a plugin or module was updated) can be used as a trust indicator, with the time of a maintenance activity being within a maintenance activity time period from a present time indicating the user can be trusted.

In some embodiments, trust indicators that indicate a user is trustworthy may include whether a domain web site associated with a user's email address employs a cybersecurity suite to protect the web site against online threats. A cybersecurity suite typically includes multiple cybersecurity tools, such as firewalls, antivirus, anti-malware, intrusion detection, encryption, and vulnerability scanning, that work together to secure the site's servers, data, and user connections. Thus, that a web service utilizes a plurality of cybersecurity tools can be an indication that the user is to be trusted.

In some embodiments, a trust indicator can be whether a domain name associated with a user's email address is a parked website. A parked website refers to a domain name that has been registered but is not associated with active website content. Instead, the domain may resolve to a placeholder page, such as a default page provided by the registrar or an advertising page.

In some embodiments, the fleet service 120 can gather information available from one or more third-party reputational services as part of determining a level of trust for the user 124. Such services can maintain databases of known email addresses and associated activity, and generate a score or evaluation based on observed usage patterns, prior incidents, or correlations with malicious behavior, which can be provided to the fleet service 120. The fleet service 120 can combine a reputational score or evaluation for the user 124 provided by the third-party reputation service with other trust indicators to determine a level of trust for a user.

After a level of trust for a user 124, as determined by the fleet service 120, is deemed to be sufficient, the fleet service 120 registers the user 124, and the user is then able to request from the fleet service 120 activation tokens that the user 124 can use to provision endpoint devices for out-of-band management.

In the second stage 132 of the sequence illustrated in FIG. 1, a user 124 requests an activation token from the fleet service 120 in an operation 140. An activation token can be submitted by a user 124 to a fleet service 120 to provision one or more endpoint device for out-of-band management by the user 124. An activation token is associated with a particular user and can have time and usage limits. In some embodiments, a fleet service 120 can issue single-use and/or multi-use activation tokens. Single use tokens can be used to provision a single endpoint device for out-of-band management. In some embodiments, single use tokens are only valid for a specified length of time, are valid only until a certain date, or have another suitable time limit. Multi-use activation tokens can be used to provision multiple devices. In some embodiments, multi-use activation tokens are only valid for a specified length of time, are valid only until a certain date, or have other suitable time limits. In some embodiments, a multi-use activation token can only be used to provision a specified number of endpoint devices. An activation token can comprise any suitable data (e.g., a code, a hash), in any suitable form (e.g., encrypted, plaintext), and comprise any suitable data structure (e.g., blob).

Upon receipt of an activation token request, the fleet service 120 performs a challenge-response authentication to authenticate the user. The challenge-response authentication can comprise the fleet service 120 issuing a challenge value (operation 144) to the user and issues an activation code to the user only if the user returns the correct response (operation 148). In some embodiments, a challenge-response authentication can involve transmitting a one-time nonce to a user, wherein the user is prompted to enter the nonce into a computing device, and the system validates that the entered value matches the originally issued nonce. In other embodiments, the system may issue a cryptographic challenge that requires the client to compute a keyed hash of the nonce using a stored secret, or to digitally sign the nonce using a private key, thereby enabling the system to verify possession of the corresponding secret or key. In still further embodiments, the challenge-response procedure may involve multi-factor authentication, such as issuing a time-based one-time password (TOTP) challenge or sending a verification token via email or SMS (short message service) that the user must return to complete authentication. The challenge-response authentication process can comprise a time-out period. That is, if the user does not provide the appropriate response in a specified amount of time, the fleet service 120 ends the activation token request process and an activation token is not issued to the user. If the user supplies the proper response, the fleet service 120 issues an activation token to the user at an operation 152. In some embodiments, a fleet service does not perform a challenge-response authentication as part of satisfying an activation token request.

In some embodiments, a trust level of the user is determined by the fleet service 120 prior to issuing an activation token to the user. In some embodiments, this trust level determination can be the same type of trust determination performed by the fleet service 120 when the user registered with the fleet service 120. This second trust determination is performed to ensure that the user 124 can be trusted (which can be important if, for example, a lengthy period of time has transpired since the user registered with the fleet service) and can comprise evaluating the same trust indicators as used in the trust determination performed when the user registered, a different set of trust indicators, or more or fewer trust indicators. In some embodiments, the trust determination performed by the fleet service 120 as part of issuing an activation token may not be performed until a specified amount of time has elapsed since the user registered with the fleet service 120. This cooling off period can help protect against fraudulent use of the user's email account. In some embodiments, a second trust determination performed as part of handling an activation token request may not be performed, and the fleet service 120 relies upon just on the trust determination performed during user registration.

In the third stage 136 of the sequence illustrated in FIG. 1, an endpoint device 116 is provisioned for out-of-band management by the user 124. In an operation 156, the user 124 submits to the fleet service 120 an activation token received in the second stage, along with information indicating the endpoint device 116 to be managed. In an operation 160, the fleet service 120 sends the activation token to the endpoint device 116, along with additional information, such as a TLS certificate or public key hash (key hash) identifying the sending fleet system server, a root of trust defining a foundational cryptographic authority, and information specifying the user 124 that will remotely manage the endpoint device. The TLS certificate or key hash enables the endpoint device 116 to authenticate the fleet service server by verifying the TLS certificate or key hash against a list of trusted certificates or key hashes preloaded at the endpoint device 116. The root of trust serves as the cryptographic anchor for the entire trust chain, providing a reference point for the endpoint device to verify the fleet service server's TLS certificate. In embodiments where the out-of-band management platform is Intel® Active Management, Intel® can be the root of trust. In other embodiment, the root of trust can be another original equipment manufacturer (OEM)-trusted certificate authority.

The activation token and the additional information can pass to a subsystem of the endpoint device that is responsible for managing out-of-band management of the endpoint (i.e., a management subsystem). In some embodiments, the activation token and the additional information can be submitted to the endpoint device as code that is executed at the endpoint device. be submitted to the endpoint device 116 as code that is executed by the endpoint device 116. Execution of this code uses the endpoint device's administrator privileges to pass the activation token and additional information. In some embodiments, this management subsystem can operate independently of the operating system of the endpoint device. In some embodiments, this management subsystem can further operate on a processing unit that is separate from one or more other processing units that execute an operating system of the endpoint device. In some embodiments, this management system is an Intel® Converged Security and Management Engine (CSME) or an Intel® Manageability Engine (ME).

The management subsystem of the endpoint device can confirm the identity of the fleet service server by determining whether the provided root of trust information identifies a root of trust that is known to the management subsystem, and/or by comparing the TLS certificate or key hash against certificates and key hashes preloaded at the management subsystem.

In some embodiments, as an added layer of security, the physical presence of the user responsible for out-of-band management (e.g., user 124) in proximity to the endpoint device 116 can be verified. This can be done by, for example, a code being shown on a display of the endpoint device, which can be conveyed by a mobile computing device the user to the fleet service 120 by, for example, using a communication protocol requiring a degree of physical proximity between the endpoint device 116 and the user (e.g., Bluetooth, Wi-Fi, audio signal communication). In some embodiments, proximity of the user to the endpoint device 116 can be based on the user's location, which can be determined by GNSS (global navigation satellite system)-based positioning subsystems of the endpoint device 116 and a user's mobile computing device, or network proximity between the user's mobile computing device and the endpoint (by, for example, analyzing network proximity characteristics, such as whether the devices share the same local network segment, access point, or exhibit low network latency indicative of close network topological or physical distance).

After the identity of the fleet service server is verified (and the user's physical proximity to the endpoint device has been verified, if such a check is performed), the endpoint device's management subsystem creates an ownership voucher request containing the activation token, some or all (or even none) of the additional information provided to the endpoint device by the fleet service server, and, optionally, information identifying the management subsystem or the endpoint device, such as a unique platform identifier (UPID). The endpoint device's management subsystem signs the ownership voucher request using the management subsystem's certificate authority (established by, for example, the management subsystem manufacturer or a trusted thirty-party entity) and sends information indicating the ownership voucher request to the fleet service 120 in an operation 164. In some embodiments, the ownership voucher request can comprise a nonce that uniquely identifies the ownership voucher request transaction and that is returned to the endpoint device 116 by the fleet service 120 with a signed ownership voucher (as discussed below).

As the fleet service 120 and the management subsystems of endpoint devices to be managed by the fleet service 120 typically belong to the same out-of-band management platform (e.g., Intel® Active Management), the fleet service 120 is aware of the certificate authorities of the management subsystems of the endpoint devices that belong to the fleet of endpoint devices under fleet service management. Upon receipt of the signed ownership voucher request from the endpoint device 116, the fleet service 120 verifies that the ownership voucher request is signed by a certificate authority known to the fleet service 120. If signature verification is successful, the activation token included in the ownership voucher request is checked against the activation token sent by the user 124 to the fleet service 120 in the operation 156. Thus, as part of validating the ownership voucher request, the fleet service 120 validates that a first activation token (received from the user 124 in the operation 156) matches a second validation activation token (received from the endpoint device 116 as part of the ownership voucher request in operation 164). In some embodiments, the fleet service 120 can further validate a unique platform ID (UPID) included in the ownership voucher check by checking the received UPID against a list of UPID known to the fleet service 120 that are associated with endpoint devices under fleet service management.

Before granting the ownership voucher request, the fleet service 120 further references time and usage limit information associated with the activation token and stored by the fleet service 120 to see if the time and usage limits have not been exceeded for the activation token (e.g., that a single-use token has not already been used, that a number of endpoint device that can provisioned with a multi-use token has not been exceeded, that the token has not expired).

After successful signature verification of the ownership voucher request, validation of the activation token, and that the activation token's usage and time limits have not been exceeded, the fleet service 120, creates an ownership voucher request, signs the ownership voucher request and provides the signed ownership voucher to the endpoint device 116 in an operation 168. In some embodiments, the fleet service 120 can sign the ownership voucher with a public key associated with a root of trust known to the management subsystem of the endpoint device 116. Upon receipt of a signed ownership voucher, the management subsystem of the endpoint device 116 verifies the signature of the signed ownership voucher (with, for example, a private key associated with a root a trust known to the management subsystem) and, if signature verification is successful, stores information indicating that the user that is allowed to place the endpoint device is a management mode where it is subject to out-of-band management in a consent-free manner. At this point, the endpoint device 116 is provisioned for out-of-band management by the user 124.

In some embodiments, upon verification of the signed ownership voucher signature, the endpoint device 116 can be placed in an out-of-band management mode (e.g., an admin control mode in Intel® Active Management-enabled endpoint devices) without consent by a user of the endpoint device 116. After the endpoint device 116 has been provisioned for out-of-band management, in subsequent requests by the user 124 to remotely manage the endpoint device 116, the third stage 136 in the sequence illustrated in FIG. 1 does not need to be repeated and the endpoint device 116 can allow for the user 124 to cause the endpoint device 116 to enter into an out-of-band management mode by authenticating the user 124 identified in a request to place the endpoint device 116 in a consent-free out-of-band management mode. Such authentication could involve the user providing a password, a password-free authentication approach (e.g., mutual TLS or JWT-based (JavaScript Object Notation) web tokens, or other authentication approach (e.g., one-time password (OTP), biometric authentication). The third stage 136 illustrated in FIG. 1 can be repeated to provision additional endpoint devices for consent-free out-of-band management by the user 124.

In the fourth stage 138 of the sequence diagram the user 124 submits out-of-band commands to the fleet service 120 to control the endpoint device 116 in an out-of-band manner via an operation 172. The fleet service 120 passes along these management commands to the endpoint device 116 in an operation 176. Upon receipt of the out-of-band management commands from the user 124, the endpoint device 116 recognizes that the commands are coming from a user authorized to remotely control the endpoint device 116 in a consent-free manner, and the endpoint device 116 allows itself to out-of-band management by the user 124 without having obtained approval by a user of the endpoint device 116.

It is to be noted, that in some embodiments, the fleet service 120 is implemented by multiple computing devices and any individual operation performed by the fleet service 120 in the sequence illustrated in FIG. 1 can be executed by one of the multiple computing devices implementing the fleet service 120.

Any of the operations, acts, or operations described herein as being performed by a computing system or device (e.g., fleet system server, endpoint device), can be performed by a corresponding module. For example, a management subsystem module of an endpoint device can perform creating an ownership voucher request, signing an ownership voucher request, and validating a certificate or key hash received from a fleet service computing device; and an ownership voucher module of a fleet system service can verifying the signature of an ownership voucher request received from an endpoint device, validate an activation token that is part of an ownership voucher request, and sign an ownership voucher.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of modules can be implemented as circuitry, such as management subsystem circuitry, ownership voucher request circuitry. A computing system referred to as being programmed to perform a method can be programmed to perform the method via software, hardware, firmware, or combinations thereof.

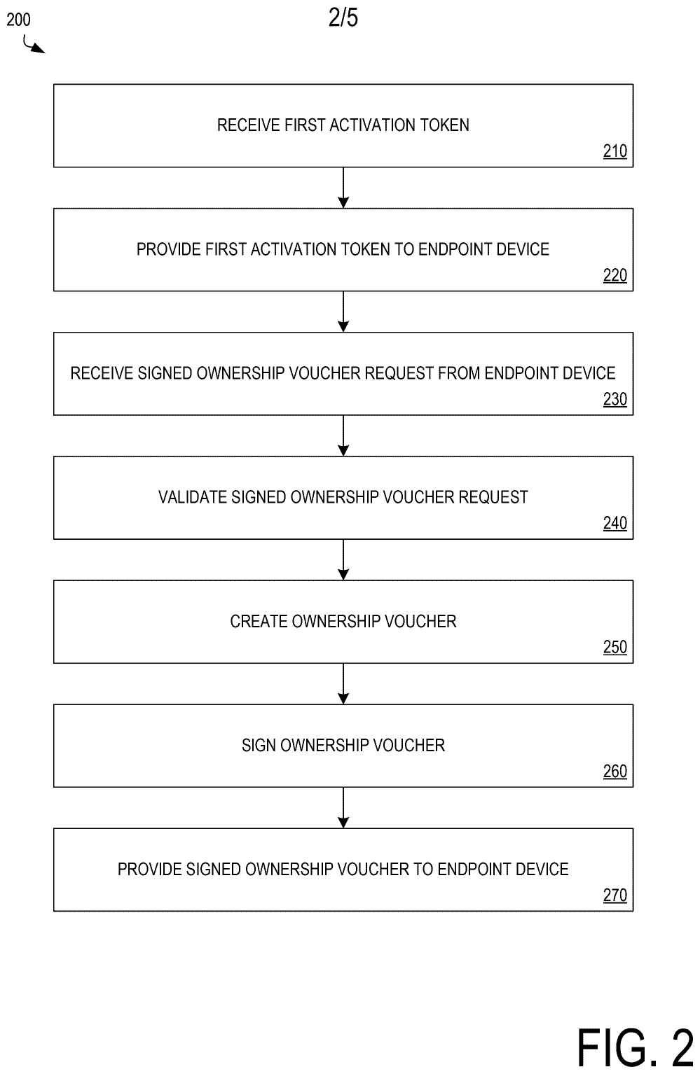

FIG. 2 is an example method performed by a fleet server as part of provisioning an endpoint device for consent-free out-of-band management. The method 200 can be performed by, for example, one or more servers that are part of a fleet service. In stage 210, a first activation token is received for out-of-band management, the first activation token associated with a user. In stage 220, the first activation token is provided to an endpoint device. In stage 230, a signed ownership voucher request comprising a second activation token is received from the endpoint device. In stage 240, the signed ownership voucher request is validated. In stage 250, an ownership voucher is created. In stage 260, an ownership voucher is signed to create a signed ownership voucher. In stage 270, the signed ownership voucher is provided to the endpoint device.

In other embodiments, the method 200 can comprise one or more additional elements. For example, the method 200 can further comprise determining a level of trust for the user; and determining that the level of trust for the user exceeds a trust threshold. In another example, the method 200 can further comprise, prior to receiving the first activation token: receiving, from a computing device, an activation token request comprising information identifying a user; performing a challenge-response authentication to authenticate the user; and providing, to the computing device, the first activation token to the user if the challenge-response authentication is successful, wherein the first activation token is associated with the user.

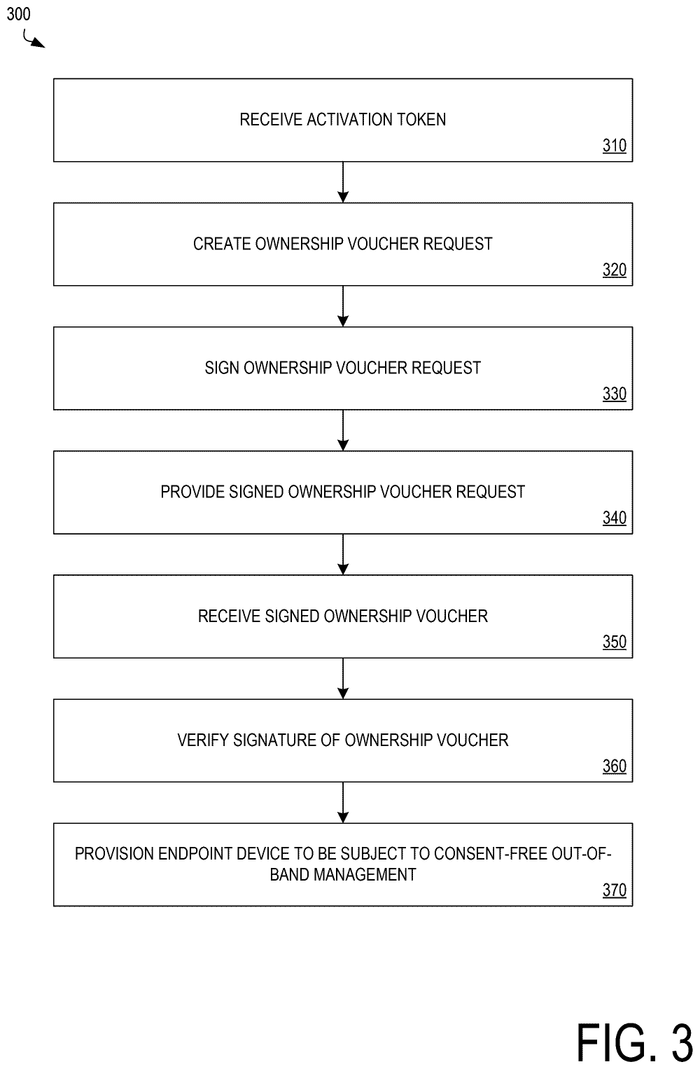

FIG. 3 is an example method performed by an endpoint device as part of provisioning the endpoint device for consent-free out-of-band management. The method 300 can be performed by, for example, a laptop computer or another client device. In stage 310 an endpoint device receives from a computing device, an activation token associated with a user. In stage 320, an ownership voucher request is created at the computing device. In stage 330, the ownership voucher request is signed. In stage 340, the ownership voucher request is provided to the computing device. In stage 350, an ownership voucher is received from the computing device. In stage 360 verifying a signature of the ownership voucher is verified. In stage 370, at the endpoint device, the endpoint device is provisioned to be subject to consent-free out-of-band management by the user.

The technologies described herein can be performed by or implemented in any of a variety of computing systems, including mobile computing systems (e.g., smartphones, handheld computers, tablet computers, laptop computers, 2-in-1 convertible computers, portable all-in-one computers), non-mobile computing systems (e.g., desktop computers, servers, workstations, rack-level computing solutions (e.g., blade, tray, or sled computing systems)), and embedded computing systems (e.g., computing systems that are part of a vehicle, consumer electronics product or equipment, manufacturing equipment).

As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), or an edge data center (e.g., a data center typically having a smaller footprint than other data center types, located close to the geographic area that it serves).

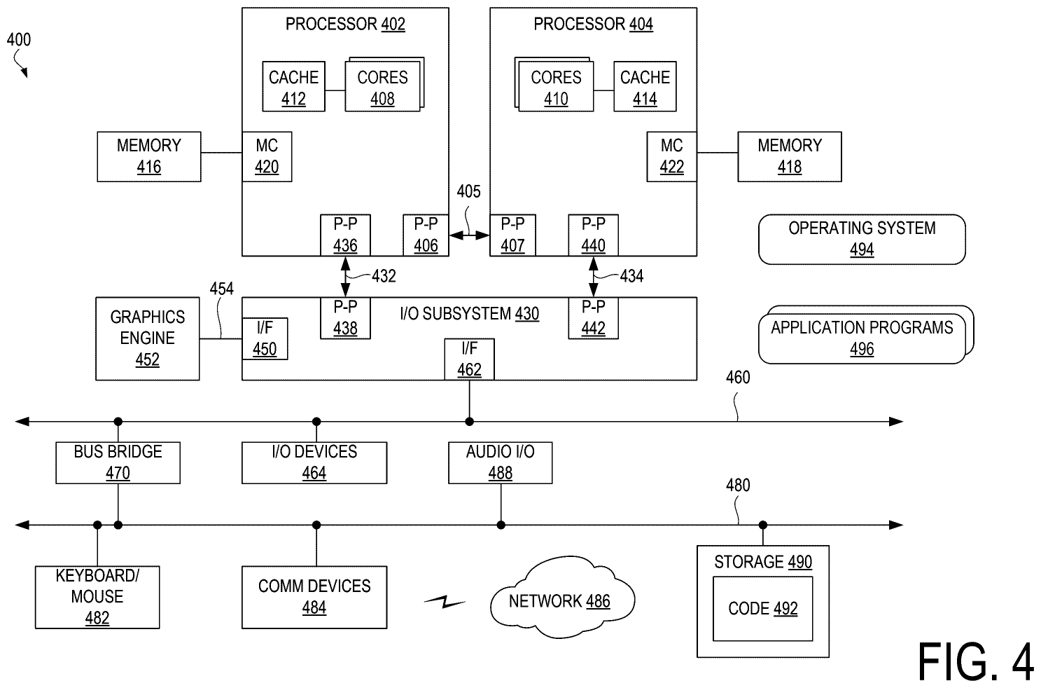

FIG. 4 is a block diagram of a second example computing system in which technologies described herein may be implemented. Generally, components shown in FIG. 4 can communicate with other shown components, although not all connections are shown, for ease of illustration. The computing system 400 is a multiprocessor system comprising first processor unit 402 and second processor unit 404 comprising point-to-point (P-P) interconnects. A point-to-point (P-P) interface 406 of the first processor unit 402 is coupled to a point-to-point interface 407 of the second processor unit 404 via a point-to-point interconnection 405. It is to be understood that any or all of the point-to-point interconnects illustrated in FIG. 4 can be alternatively implemented as a multi-drop bus, and that any or all buses illustrated in FIG. 4 could be replaced by point-to-point interconnects.

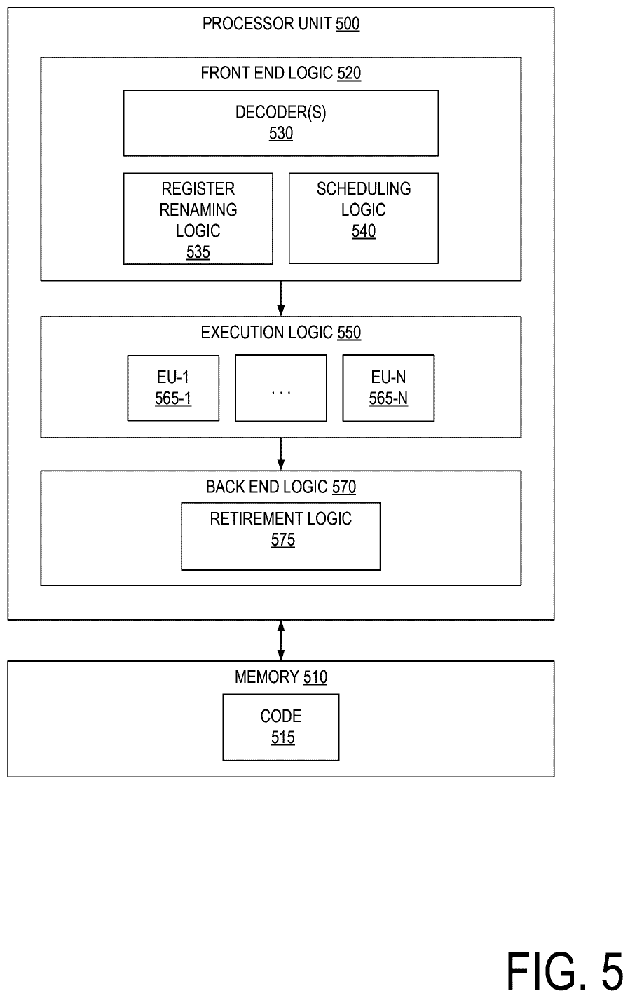

The first processor unit 402 and second processor unit 404 comprise multiple processor cores. The first processor unit 402 comprises processor cores 408 and the second processor unit 404 comprises processor cores 410. Processor cores 408 and 410 can execute computer-executable instructions in a manner similar to that discussed below in connection with FIG. 5, or other manners.

The first processor unit 402 and the second processor unit 404 further comprise cache memories 412 and 414, respectively. The cache memories 412 and 414 can store data (e.g., instructions) utilized by one or more components of the first processor unit 402 and the second processor unit 404, such as the processor cores 408 and 410. The cache memories 412 and 414 can be part of a memory hierarchy for the computing system 400. For example, the cache memories 412 can locally store data that is also stored in a first memory 416 to allow for faster access to the data by the first processor unit 402. In some embodiments, the cache memories 412 and 414 can comprise multiple cache memories that are a part of a memory hierarchy. The cache memories in the memory hierarchy can be at different cache memory levels, such as level 1 (L1), level 2 (L2), level 3 (L3), level 4 (L4), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 400 is shown with two processor units, the computing system 400 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 400 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 402 and the second processor unit 404 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 402 further comprises first memory controller logic (first MC 420) and the second processor unit 404 further comprises second memory controller logic (second MC 422). As shown in FIG. 4, a first memory 416 coupled to the first processor unit 402 is controlled by the first MC 420 and a second memory 418 coupled to the second processor unit 404 is controlled by the second MC 422. The first memory 416 and the second memory 418 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 416 and the second memory 418 can comprise one or more layers of a memory hierarchy of the computing system. While first MC 420 and second MC 422 are illustrated as being integrated into the first processor unit 402 and the second processor unit 404, in alternative embodiments, memory controller logic can be external to a processor unit.

The first processor unit 402 and the second processor unit 404 are coupled to an Input/Output subsystem 430 (1/O subsystem) via point-to-point interconnections. The point-to-point interconnection 432 connects a point-to-point interface 436 of the first processor unit 402 with a point-to-point interface 438 of the Input/Output subsystem 430, and the point-to-point interconnection 434 connects a point-to-point interface 440 of the second processor unit 404 with a point-to-point interface 442 of the Input/Output subsystem 430. Input/Output subsystem 430 further includes an interface 450 to couple the Input/Output subsystem 430 to a graphics engine 452. The Input/Output subsystem 430 and the graphics engine 452 are coupled via a bus 454.

The Input/Output subsystem 430 is further coupled to a first bus 460 via an interface 462. The first bus 460 can be a Peripheral Component Interconnect Express (PCIe) bus or any other type of bus. Various I/O devices 464 can be coupled to the first bus 460. A bus bridge 470 can couple the first bus 460 to a second bus 480. In some embodiments, the second bus 480 can be a low pin count (LPC) bus. Various devices can be coupled to the second bus 480 including, for example, a keyboard/mouse 482, audio I/O devices 488, and a storage device 490, such as a hard disk drive, solid-state drive, or another storage device for storing computer-executable instructions (or code 492) or data. The code 492 can comprise computer-executable instructions for performing methods described herein. Additional components that can be coupled to the second bus 480 include one or more communication devices 484, which can provide for communication between the computing system 400 and one or more wired or wireless networks 486 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 484 support wireless communication, the one or more communication devices 484 can comprise wireless communication components coupled to one or more antennas to support communication between the computing system 400 and external devices. The wireless communication components can support various wireless communication protocols and technologies such as IEEE 1002.11 (Wi-Fi) variants. In addition, the wireless modems can support communication with one or more cellular networks for data and voice communications within a single cellular network, between cellular networks, or between the computing system and a public switched telephone network (PSTN).

The computing system 400 can comprise removable memory such as flash memory cards (e.g., SD (Secure Digital) cards), memory sticks, Subscriber Identity Module (SIM) cards). The memory in computing system 400 (including cache memories 412 and 414, first memory 416, second memory 418, and storage device 490) can store data and/or computer-executable instructions for executing an operating system 494 and application programs 496. The computing system 400 can also have access to external memory or storage (not shown) such as external hard drives or cloud-based storage.

The operating system 494 can control the allocation and usage of the components illustrated in FIG. 4 and support the application programs 496. The application programs 496 can include common computing system applications (e.g., email applications) as well as other computing applications.

The computing system 400 can support various additional input devices, such as a touchscreen, microphone, camera, trackball, touchpad, light sensor, electrocardiogram (ECG) sensor, and one or more output devices, such as one or more speakers or displays. Any of the input or output devices can be internal to, external to, or removably attachable with the computing system 400. External input and output devices can communicate with the computing system 400 via wired or wireless connections.

The computing system 400 can further include at least one input/output port comprising physical connectors (e.g., USB, FireWire, Ethernet, RS-232), a power supply (e.g., battery) and a global satellite navigation system (GNSS) receiver (e.g., GPS receiver). A GNSS receiver can be coupled to a GNSS antenna. The computing system 400 can further comprise one or more additional antennas coupled to one or more additional receivers, transmitters, and/or transceivers to enable additional functions.

It is to be understood that FIG. 4 illustrates only one example computing system architecture. Computing systems based on alternative architectures can be used to implement technologies described herein. For example, instead of the first processor unit 402, the second processor unit 404, and the graphics engine 452 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 4. Moreover, the illustrated components in FIG. 4 are not required or all-inclusive, as shown components can be removed and other components added in alternative embodiments.

FIG. 5 is a block diagram of an example processor unit to execute computer-executable instructions as part of implementing technologies described herein. The processor unit 500 can be a single-threaded core or a multithreaded core in that it may include more than one hardware thread context (or “logical processor”) per processor unit.

FIG. 5 also illustrates a memory 510 coupled to the processor unit 500. The memory 510 can be any memory described herein or any other memory known to those of skill in the art. The memory 510 can store computer-executable instructions 515 (code) executable by the processor unit 500.

The processor unit comprises front-end logic 520 that receives instructions from the memory 510. An instruction can be processed by one or more decoders 530. The one or more decoders 530 can generate as its output a micro-operation such as a fixed width micro-operation in a predefined format, or generate other instructions, microinstructions, or control signals, which reflect the original code instruction. The front-end logic 520 further comprises register renaming logic 535 and scheduling logic 540, which generally allocate resources and queues operations corresponding to converting an instruction for execution.

The processor unit 500 further comprises execution logic 550, which comprises one or more execution units (EUs) (execution unit 565-1 through execution unit 565-N). Some processor unit embodiments can include a number of execution units dedicated to specific functions or sets of functions. Other embodiments can include only one execution unit or one execution unit that can perform a particular function. The execution logic 550 performs the operations specified by code instructions. After completion of execution of the operations specified by the code instructions, back-end logic 570 retires instructions using retirement logic 575. In some embodiments, the processor unit 500 allows out of order execution but requires in-order retirement of instructions. Retirement logic 575 can take a variety of forms as known to those of skill in the art (e.g., re-order buffers or the like).

The processor unit 500 is transformed during execution of instructions, at least in terms of the output generated by the one or more decoders 530, hardware registers and tables utilized by the register renaming logic 535, and any registers (not shown) modified by the execution logic 550.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used herein, the term “connected” may indicate elements are in direct physical or electrical contact with each other and the term “coupled” may indicate elements cooperate or interact with each other, but they may or may not be in direct physical or electrical contact. Furthermore, the terms “comprising,” “including,” “having,” and the like, as used with respect to embodiments of the present disclosure, are synonymous.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

As used in this application and the claims, a list of items joined by the term “and/or” can mean any combination of the listed items. For example, the phrase “A, B, and/or C” can mean A; B; C; A and B; A and C; B and C; or A, B and C. As used in this application and the claims, a list of items joined by the term “at least one of” can mean any combination of the listed terms. For example, the phrase “at least one of A, B, or C” can mean A; B; C; A and B; A and C; B and C; or A, B, and C. Further, as used in this application and the claims, a list of items joined by the term “one or more of” can mean any combination of the listed terms. For example, the phrase “one or more of A, B, and C” can mean A; B; C; A and B; A and C; B and C; or A, B, and C. Moreover, as used in this application and the claims, a list of items joined by the term “one of” can mean any one of the listed terms. For example, the phrase “one of A, B, or C” can mean A, B, or C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a method comprising: receiving an activation token for provisioning an endpoint device for out-of-band management, the activation token associated with a user; providing the activation token to an endpoint device; receiving, from the endpoint device, a signed ownership voucher request comprising a second activation token; validating the signed ownership voucher request; creating an ownership voucher; signing an ownership voucher to create a signed ownership voucher; and providing the signed ownership voucher to the endpoint device.

Example 2 comprises method of example 1, wherein the activation token is for provisioning an endpoint device for consent-free out-of-band management.

Example 3 comprises method of example 1 or 2, further comprising: determining a level of trust for the user; and determining that the level of trust for the user exceeds a trust threshold.

Example 4 comprises method of example 3, further comprising registering the user for an out-of-band management service if the level of trust exceeds a threshold.

Example 5 comprises method of example 3, further comprising, prior to receiving the activation token: receiving, from a computing device, an activation token request comprising information identifying a user; performing a challenge-response authentication to authenticate the user; and providing, to the computing device, the activation token to the user if the challenge-response authentication is successful.

Example 6 comprises method of example 5, wherein determining that the level of trust for the user exceeds a trust threshold is performed before providing the activation token to the user and the activation token is provided to the user if the level of trust for the user exceeds the trust threshold.

Example 7 comprises method of example 6, wherein the method of example 3 is not performed a second time until a specified amount of time has elapsed from a first time the method of example 3 is performed.

Example 8 comprises method of example 3, wherein determining the level of trust of the user is based at least in part on one or more of an email address of the user and an internet protocol address associated with the email address of the user.

Example 9 comprises method of example 3, wherein determining the level of trust of the user is based at least in part on one or more of a registration date, an update date, and an expiration date associated with a domain that is associated with an email address of the user.

Example 10 comprises method of example 3, wherein determining the level of trust of the user is based at least in part on one or more domain status codes for a domain associated with an email address of the user.

Example 11 comprises method of example 3, wherein determining the level of trust of the user is based at least in part on registrar information associated with an email address of the user and/or registrant information associated with the email address of the user and maintained by a registrar or registry.

Example 12 comprises method of example 3, wherein determining the level of trust of the user is based at least in part on a location of a name server, wherein the location is inferred from an email address of the user and/or a domain of the name server.

Example 13 comprises method of example 3, wherein determining the level of trust of the user is based at least in part on one or more of a domain name server (DNS) address record, a DNS name server record, a DNS mail exchange record, a DNS canonical name record, a DNS start of authority record, and a DNS text record.

Example 14 comprises method of example 3, wherein determining the level of trust of the user is based at least in part on determining whether an email server associated with a domain associated with an email address of the user provides a temporary or disposable email service.

Example 15 comprises method of example 3, wherein determining the level of trust of the user is based at least in part on determining whether an email server associated with a domain associated with an email address of the user provides a common or shared email service.

Example 16 comprises method of example 3, wherein determining the level of trust of the user is based at least in part on an internet protocol (IP) address of a domain associated with an email address associated with the user.

Example 17 comprises method of example 3, wherein determining the level of trust of the user is based at least in part on a geographic location inferred from an internet protocol (IP) address of a domain associated with an email address associated with the user.

Example 18 comprises method of example 3, wherein determining the level of trust of the user is based at least in part on whether a domain name has a transport layer security certificate (TLS certificate).

Example 19 comprises method of example 18, wherein determining the level of trust of the user is based at least in part on whether the TLS certificate is chained to a certificate authority.

Example 20 comprises method of example 18, wherein determining the level of trust of the user is based at least in part on whether a domain name identifier in the TLS certificate matches that of a domain associated with the user.

Example 21 comprises method of example 18, wherein determining the level of trust of the user is based at least in part on whether a domain name identifier in the TLS certificate comprises wildcards.

Example 22 comprises method of example 3, wherein determining the level of trust of the user is based at least in part on whether a web site associated with a domain associated with an email address associated with the user is a parked web site.

Example 23 comprises method of example 3, wherein determining the level of trust of the user is based at least a maintenance activity associated with maintaining a domain web site associated with an email address associated with the user being within a maintenance activity time period from a current time, wherein the maintenance activity is associated with maintaining the domain web site to remain effective against techniques used to bypass website security.

Example 24 comprises method of any one of examples 1-23, wherein validating the signed ownership voucher request further comprises confirming that a time limit associated with the activation token and a usage limit associated with the activation token have not been exceeded.

Example 25 comprises method of any one of examples 1-24, wherein the activation token is a single use token.

Example 26 comprises method of any one of examples 1-24, wherein the activation token is a multi-use token.

Example 27 comprises method of any one of examples 1-26, wherein validating the signed ownership voucher request comprises verifying a signature of the signed ownership voucher request.

Example 28 comprises method of any one of examples 1-26, wherein the activation token is a first activation token and the signed ownership voucher request comprises a second activation token, the method further comprising validating the signed ownership voucher request comprises validating that the first activation token matches the second activation token.

Example 29 comprises method of any one of examples 1-28, further comprising: receiving an out-of-band management command, the out-of-band management command associated with the user; and providing the out-of-band management command to the endpoint device.

Example 30 is one or more computer-readable storage media storing instructions that, when executed, cause a computing system to perform the method of any one of examples 1-28.

Example 31 is one or more computing devices comprising: one or more processors; and one or more computer-readable storage media storing instructions that, when executed, cause the one or more computing devices to perform the method of any one of examples 1-28.

Example 32 is a method comprising: receiving, at an endpoint device from a computing device, an activation token associated with a user; creating, at the computing device, an ownership voucher request; signing the ownership voucher request; providing the ownership voucher request to the computing device; receiving an ownership voucher from the computing device; verifying a signature of the ownership voucher; and provisioning, at the endpoint device, the endpoint device to be subject to consent-free out-of-band management by the user.

Example 33 comprises method of example 32, wherein creating the ownership voucher request is performed by a processing unit that operates independently of one or more processing units that operate an operating system of the endpoint device.

Example 34 comprises method of example 32, wherein creating the ownership voucher request, signing the ownership voucher request, and provisioning the endpoint device to be subject to consent-free out-of-band management is performed by a processing unit that operates independently of one or more processing units that operate an operating system of the endpoint device.

Example 35 comprises method of example 32, further comprising entering, by the endpoint device, into an out-of-band management mode without consent by a user of the endpoint device.

Example 36 is one or more computer-readable storage media storing instructions that, when executed, cause a computing system to perform the method of any one of examples 32-35.

Example 37 is one or more computing devices comprising: one or more processors; and one or more computer-readable storage media storing instructions that, when executed, cause the one or more computing devices to perform the method of any one of examples 32-35.

1. A method comprising:
receiving an activation token for provisioning an endpoint device for out-of-band management, the activation token associated with a user;
providing the activation token to an endpoint device;
receiving, from the endpoint device, a signed ownership voucher request comprising a second activation token;
validating the signed ownership voucher request;
creating an ownership voucher;
signing an ownership voucher to create a signed ownership voucher; and
providing the signed ownership voucher to the endpoint device.

2. The method of claim 1, further comprising:
determining a level of trust for the user; and
determining that the level of trust for the user exceeds a trust threshold.

3. The method of claim 2, further comprising, prior to receiving the activation token:
receiving, from a computing device, an activation token request comprising information identifying a user;
performing a challenge-response authentication to authenticate the user; and
providing, to the computing device, the activation token to the user if the challenge-response authentication is successful.

4. The method of claim 2, wherein determining that the level of trust for the user exceeds a trust threshold is performed before providing the activation token to the user and the activation token is provided to the user if the level of trust for the user exceeds the trust threshold.

5. The method of claim 2, wherein determining the level of trust of the user is based at least in part on one or more of an email address of the user and an internet protocol address associated with the email address of the user.

6. The method of claim 2, wherein determining the level of trust of the user is based at least in part on one or more of a registration date, an update date, and an expiration date associated with a domain that is associated with an email address of the user.

7. The method of claim 2, wherein determining the level of trust of the user is based at least in part on one or more domain status codes for a domain associated with an email address of the user.

8. The method of claim 2, wherein determining the level of trust of the user is based at least a maintenance activity associated with maintaining a domain web site associated with an email address associated with the user being within a maintenance activity time period from a current time, wherein the maintenance activity is associated with maintaining the domain web site to remain effective against techniques used to bypass website security.

9. The method of claim 1, wherein validating the signed ownership voucher request comprises verifying a signature of the signed ownership voucher request.

10. One or more computer-readable storage media storing instructions that, when executed, cause one or more computing systems to:
receive an activation token for provisioning an endpoint device for consent-free out-of-band management, the activation token associated with a user;
provide the activation token to an endpoint device;
receive, from the endpoint device, a signed ownership voucher request comprising a second activation token;
validate the signed ownership voucher request;
create an ownership voucher;
sign an ownership voucher to create a signed ownership voucher; and
provide the signed ownership voucher to the endpoint device.

11. The one or more computer-readable storage media of claim 10, wherein the instructions, when executed, further cause the one or more computing systems to:
determine a level of trust for the user before providing the activation token to the user; and
determine that the level of trust for the user exceeds a trust threshold, wherein the activation token is provided to the user if the level of trust for the user exceeds the trust threshold.

12. The one or more computer-readable storage media of claim 11, wherein to determine the level of trust of the user is based at least in part on one or more of a domain name server (DNS) address record, a DNS name server record, a DNS mail exchange record, a DNS canonical name record, a DNS start of authority record, and a DNS text record.

13. The one or more computer-readable storage media of claim 10, wherein to validate the signed ownership voucher request further comprises to confirm that a time limit associated with the activation token and a usage limit associated with the activation token have not been exceeded.

14. The one or more computer-readable storage media of claim 10, wherein to validate the signed ownership voucher request comprises to verify a signature of the signed ownership voucher request.

15. The one or more computer-readable storage media of claim 10, wherein the activation token is a first activation token and the signed ownership voucher request comprises a second activation token, the instructions, when executed, to further cause the one or more computing systems to validate the signed ownership voucher request comprises to validate that the first activation token matches the second activation token.

16. One or more computing devices comprising:
one or more processors; and
one or more computer-readable storage media storing instructions that, when executed, cause the one or more computing devices to:
receive an activation token for provisioning an endpoint device for consent-free out-of-band management, the activation token associated with a user;
provide the activation token to an endpoint device;
receive, from the endpoint device, a signed ownership voucher request comprising a second activation token;
validate the signed ownership voucher request;
create an ownership voucher;
sign an ownership voucher to create a signed ownership voucher; and
provide the signed ownership voucher to the endpoint device.

17. The one or more computing devices of claim 16, wherein the instructions, when executed, further cause the one or more computing devices to:
determine a level of trust for the user before providing the activation token to the user; and
determine that the level of trust for the user exceeds a trust threshold, wherein the activation token is provided to the user if the level of trust for the user exceeds the trust threshold.

18. The one or more computing devices of claim 17, wherein to determine the level of trust of the user is based at least in part on whether a transport layer security certificate of a domain name associated with an email address of the user is chained to a certificate authority.

19. The one or more computing devices of claim 17, wherein to determine the level of trust of the user is based at least in part on whether a domain name identifier in a transport layer security certificate of a domain name associated with an email address of the user comprises wildcards.

20. The one or more computing devices of claim 17, wherein to validate the signed ownership voucher request comprises to verify a signature of the signed ownership voucher request.
